(19) United States
(12) Patent Application Publication
(10) Pub. No.: US 2013/0309383 A1
(43) Pub. Date: Nov. 21, 2013

(54) Wafer For Frozen Confections

(71) Applicant: Maureen Elizabeth Fagan, Newark, DE (US)

(72) Inventor: Maureen Elizabeth Fagan, Newark, DE (US)

(21) Appl. No.: 13/475,254

(22) Filed: May 18, 2012

(51) Int. Cl. A21D 2/36

(52) U.S. Cl. 426/549

(57) ABSTRACT

A carob wafer for use with frozen confections using a combination of ingredients which include flour, sweeteners, extra virgin olive oil, carob powder, cinnamon, vanilla and water. The cinnamon and vanilla can be optional but if used organic is preferred. When molasses is used as the sweetener, unsulphured organic molasses is preferred. The flour is preferably unbleached white, whole wheat, spelt, oat flour, organic sprouted whole wheat, organic sprouted spelt, organic millet and brown rice flour. Flours should be organic and sprouted if available. Other sweeteners besides molasses such as honey and date sugar can be used as desired.

### BACKGROUND OF THE INVENTION

1. Field of the Invention

The present invention relates generally to wafers and more specifically to an improved wafer for frozen confectionaries such as ice cream sandwiches or any other food product generally used with ice cream.

2.Description of Related Art

Wafers for frozen confections is known in the prior art. More specifically, by way of example, U.S. PreGrant Publication No. 2010/0034931 to Justi discloses a crisp and crunchy reconstituted biscuit composed of fragments of baked biscuit, agglomerated within a binder having carbohydrate and fat where the biscuit has the characteristic feature of preserving its crunchiness during storage at a negative temperature.

U.S. PreGrant Publication No. 2008/0206404 to Green, et al. discloses a reformed biscuit product suitable for forming composite frozen compositions which includes a solid mixture of a particulate cooked biscuit material and a cocoa butter equivalent of a confectionery fat.

U.S. PreGrant Publication No. 2007/0122528 to Cathenaut, et al. discloses a wafer protected from moisture at least on its surface which is in contact with the center of water ice, by a barrier layer.

U.S. Pat. No. 7,229,654 to Gaonkar, et al. discloses an edible multilayer moisture barrier for food products for separating food components having different water activities and preventing or inhibiting movement of water between the food components. The edible multilayer moisture barrier includes a lipid layer and a flexible hydrophobic layer.

U.S. Pat. No. 6,177,112 to Dufort, et al. discloses a composite product which includes an ice cream, and a pastry prepared by superposing filo pastry so that a layered pastry product is formed which has alternating layers of pastry and a fat, where the layered pastry product is shaped for containing an ice confectionery substance.

U.S. Pat. No. 5,789,008 to Monte discloses an ice cream sandwich which includes a layer of ice cream intermediate a pair of crispy cookies where the cookies resist migration of moisture from the ice cream and remain crisp during storage. An edible oil and food membrane on the cookies prevents moisture in the ice cream from being absorbed by the cookies.

U.S. Pat. No. 5,543,164 to Krochta, et al. discloses aqueous protein solutions which are denatured with heat, chemicals or enzymes to induce thiol-disulfide interchange and thiol oxidation reactions which form intermolecular and intramolecular disulfide crosslinkages. The formation of covalent intermolecular crosslinkages in protein-based edible films and coatings result in films having barrier and mechanical properties which are insoluble in water.

U.S. Pat. No. 5,182,123 to Edo, et al. discloses a composite laminated dough prepared by superposing two different laminated doughs upon each other, each obtained by wrapping a fat in a dough of wheat flour and by performing a rolling and folding procedure.

### SUMMARY OF THE INVENTION

In an exemplary embodiment of the present invention, there is disclosed a recipe of ingredients for making a carob wafer for frozen confections combined in amounts indicated and baked at 350 degrees F. for about 25 minutes, more or less comprising:

| | | | |
|---|---|---|---|
| Whole wheat/ | 1. At least ⅓ cup and no | ¾ | cup water |
| unbleached | more than ⅔ cup of | | |
| white flour/ | molasses; | | |
| sprouted whole | 2. At least ⅓ cup and no | ¾ | cup water |
| wheat flour | more than ½ cup of honey; | | |
| (2 cups) | 3. At least ⅓ cup and no | 1 | cup water |
| | more than ½ cup of date | | |
| | sugar | | |
| Spelt flour/ | 1. At least ⅓ cup and no | ¾ | cup water |
| sprouted Spelt | more than ½ cup of molasses; | | |
| flour (2 cups) | 2. At least ¼ cup and no | ½ | cup water |
| | more than ⅓ cup of honey; | | |
| | 3. At least ⅓ cup and no more | 1 | cup water |
| | than ½ cup of date sugar; | | |
| Oat flour | 1. At least ⅓ cup and no | ½ | cup water |
| (2 cups) | more than ½ cup of molasses; | | |
| | 2. At least ¼ cup and no more | ¾ | cup water |
| | than ⅓ cup of honey; | | |
| | 3. At least ⅓ cup and no more | 1 | cup water |
| | than ½ cup of date sugar; | | |
| Brown rice | 1. At least ⅓ cup and no | ½ | cup water |
| Flour (2 cups) | more that ½ cup of | | |
| | molasses | | |
| | 2. At least ¼ cup and no more | 1 | cup water |
| | than ½ cup of honey; | | |
| | 3. At least ⅓ cup and no | 1 | cup water |
| | more than ½ cup of date sugar; | | |
| Carob powder | At least ⅓ and no more | | |
| | than ½ cup; | | |
| Cinnamon | 1 tablespoon; | | |
| Extra virgin | At least 4 tablespoons and no | | |
| olive oil | more than 5; | | |
| Vanilla | 1 tablespoon. | | |

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

The embodiment which has been selected to illustrate the invention relates generally to the variety of wafers known as Carob Wafers which are used with frozen confections such as a wafer ice cream sandwich or with ices, sherbets, frozen custards, confectionery icing, etc, and which is less apt to break or become soggy while being eaten.

The traditional frozen wafer is normally composed of bleached white flour, sugar, caramel color, corn sugar, vegetable shortening (partially hydrogenated oil, soybean, cotton seed oil) yellow corn flour, corn syrup, cocoa, modified corn starch, mono and Di-Glycerides, and soy lecithin. Substitute ingredients for the chocolate or chocolate liquor or chocolate chips, or the ingredients for the color which were used in the traditional recipe have been changed.

The present invention related to a carob wafer for frozen confections that can be used for those who don't like chocolate, or can't have chocolate, cocoa, chocolate liquor or chocolate chips in their frozen wafers.

A carob wafer for frozen confections produced in accordance with the principles of the invention is generally comprised of ingredients which include bleached white flour, sugar, caramel color, corn sugar, and vegetable shortening, such as partially hydrogenated soybean or cottonseed oil.

A carob wafer in accordance with the principles of the invention is comprised of ingredients which include whole wheat flour, (or unbleached white flour, spelt flour, oat flour, brown rice flour, wheat flour, organic sprouted whole wheat flour, organic sprouted spelt flour, organic millet flour), carob powder, sweetener, cinnamon, extra virgin olive oil, vanilla and water.

The foregoing ingredients are preferably combined in the proportions which follow:

| | | | |
|---|---|---|---|
| Whole wheat/ | 1. At least ⅓ cup and no | ¾ | cup water |
| unbleached | more than ⅔ cup of | | |
| white flour/ | molasses; | | |
| sprouted whole | 2. At least ⅓ cup and no | ¾ | cup water |
| Wheat flour | more than ½ cup of honey; | | |
| (2 cups) | 3. At least ⅓ cup and no | 1 | cup water |
| | more than ½ cup of date | | |
| | sugar | | |
| Spelt flour/ | 1. At least ⅓ cup and no | ¾ | cup water |
| sprouted Spelt | more than ½ cup of molasses; | | |
| flour (2 cups) | 2. At least ¼ cup and no | ½ | cup water |
| | more than ⅓ cup of honey; | | |
| | 3. At least ⅓ cup and no more | 1 | cup water |
| | than ½ cup of date sugar; | | |
| Oat flour | 1. At least ⅓ cup and no | ½ | cup water |
| (2 cups) | more than ½ cup of molasses; | | |
| | 2. At least ¼ cup and no more | ¾ | cup water |
| | than ⅓ cup of honey; | | |
| | 3. At least ⅓ cup and no more | 1 | cup water |
| | than ½ cup of date sugar; | | |
| Brown rice | 1. At least ⅓ cup and no | ½ | cup water |
| Flour (2 cups) | more that ½ cup of | | |
| | molasses | | |
| | 2. At least ¼ cup and no more | 1 | cup water |
| | than ½ cup of honey; | | |
| | 3. At least ⅓ cup and no more | 1 | cup water |
| | than ½ cup of date sugar; | | |
| Carob powder | At least ⅓ and no more | | |
| | than ½ cup; | | |
| Cinnamon | 1 tablespoon; | | |
| Extra virgin | At least 4 tablespoons and no | | |
| olive oil | more than 5; | | |
| Vanilla | 1 tablespoon; | | |

The various ingredients are mixed together and baked in an oven at 350 degrees F. for about 25 minutes, more or less. Water of different amounts is used to mix the ingredients to dough like consistency. As the Carob wafer for frozen confections can be used as a sandwich, depending on what the filling is, the amount of sweetness should be adjusted accordingly.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. A recipe of ingredients for making a carob wafer for frozen confections combined in amounts indicated and baked at 350 degrees F. for about 25 minutes, more or less comprising:

| | | | |
|---|---|---|---|
| Whole wheat/ | 1. At least ⅓ cup and no | ¾ | cup water |
| Unbleached | more than ⅔ cup of | | |
| white flour/ | molasses; | | |
| Sprouted whole | 2. At least ⅓ cup and no | ¾ | cup water |
| wheat Flour | more than ½ cup of honey; | | |
| (2 cups) | 3. At least ⅓ cup and no | 1 | cup water |
| | more than ½ cup of date | | |
| | sugar | | |
| Spelt flour/ | 1. At least ⅓ cup and no | ¾ | cup water |
| sprouted Spelt | more than ½ cup of molasses; | | |
| flour (2 cups) | 2. At least ¼ cup and no | ½ | cup water |
| | more than ⅓ cup of honey; | | |
| | 3. At least ⅓ cup and no more | 1 | cup water |
| | than ½ cup of date sugar; | | |
| Oat flour | 1. At least ⅓ cup and no | ½ | cup water |
| (2 cups) | more than ½ cup of molasses; | | |
| | 2. At least ¼ cup and no more | ¾ | cup water |
| | than ⅓ cup of honey; | | |
| | 3. At least ⅓ cup and no more | 1 | cup water |
| | than ½ cup of date sugar; | | |
| Brown rice | 1. At least ⅓ cup and no | ½ | cup water |
| Flour (2 cups) | more that ½ cup of | | |
| | molasses | | |
| | 2. At least ¼ cup and no more | 1 | cup water |
| | than ½ cup of honey; | | |
| | 3. At least ⅓ cup and no | 1 | cup water |
| | more than ½ cup of date sugar; | | |
| Organic Millet | 1. At least ⅓ cup and no | ¾ | cup water |
| Flour (2 cups)- | more than ⅔ cup of | | |
| Add | molasses; | | |
| | 2. At least ⅓ cup and no | ¾ | cup water |
| | more than ½ cup of honey; | | |
| | 3. At least ⅓ cup and no | 1 | cup water |
| | more than ½ cup of date | | |
| | sugar | | |
| Carob powder | At least ⅓ and no more | | |
| | than ½ cup; | | |
| Cinnamon | 1 tablespoon; | | |
| Olive oil | At least 4 tablespoons and no | | |
| | more than 5; | | |
| Vanilla | 1 tablespoon. | | |

2. The recipe of claim 1 wherein the molasses is unsulphured and organic.

3. The recipe of claim 1 wherein the cinnamon is organic.

4. The recipe of claim 1 wherein the vanilla is organic.

5. The recipe of claim 1 wherein the olive oil is extra virgin olive oil and organic where possible.

6. The recipe of claim 1 wherein the white flour is unbleached white flour, whole wheat, spelt, oat, brown rice flours are sprouted and organic where possible.

7. The recipe of claim 1 wherein carob powder is a chocolate substitute.

8. A recipe of ingredients for making a carob wafer for frozen confections combined in the amounts indicated and baked at 350 degrees F. for about 25 minutes, more or less comprising:

| | | | |
|---|---|---|---|
| Cinnamon | | 1 | table spoon |
| Vanilla | | 1 | table spoon |
| Carob Powder | | ½ | cup |
| Extra Virgin | | 4 | table spoons |
| Olive Oil | | | |
| Unbleached white | Molasses | ⅔ | cup |
| or | Honey | ⅓ | cup |
| Whole wheat flour/ | Date Sugar | ½ | cup |
| sprouted Whole | | | |
| wheat (2 cups) | | | |
| or | | | |
| Spelt Flour/ | Molasses | ½ | cup |
| sprouted | Honey | ⅓ | cup |
| Spelt flour | Date Sugar | ½ | cup |
| (2 cups) | | | |
| or | | | |
| Oat Flour | Molasses | ½ | cup |
| (2 cups) | Honey | ⅓ | cup |
| | Date Sugar | ½ | cup |
| or | | | |
| Brown Rice | Molasses | ½ | cup |
| Flour (2 cups) | Honey | ⅓ | cup |
| | Date Sugar | ⅓ | cup |
| or | | | |
| Organic Millet | 1. At least ⅓ cup and no | ¾ | cup water |
| Flour (2 cups) - | more than ⅔ cup of | | |
| Add | molasses; | | |
| | 2. At least ⅓ cup and no | ¾ | cup water |
| | more than ½ cup of honey; | | |
| | 3. At least ⅓ cup and no | 1 | cup water |
